(19) United States
(12) Patent Application Publication
(10) Pub. No.: US 2010/0257174 A1
(43) Pub. Date: Oct. 7, 2010

(54) Method for data compression utilizing pattern-analysis and matching means such as neural networks

(76) Inventor: Matthew Dino Minuti, Candia, NH (US)

Correspondence Address: Matthew Minuti, 404 Chester Turnpike, Candia, NH, 03034, US

(21) Appl. No.: 12/417,314

(22) Filed: Apr. 2, 2009

(51) Int. Cl. G06F 17/30

(52) U.S. Cl. 707/741; 707/E17.014

(57) ABSTRACT

A new method for data compression utilizing a neural network or other statistical technique or pattern analysis is presented. This method represents the input data as a series of vectors (21) and uses any number of error functions to guide manipulation of a matrix (35) which stores similar vectors, as well as manipulating the vectors stored within. This matrix (35), which may be of any number of dimensions, any size in each of these dimensions, acts as a lookup table in the encoding and decoding processes of the compression method. Encoding works by comparing each sequential input vector (21) to the vector stored within the matrix (35) and writing the matrix address (45) which most closely represents the input vector (21). Decoding works by reading a series of matrix addresses (45) and sequentially outputting the corresponding vector stored within each matrix address (45). As such, both the storage matrix (35) and address series (45) are needed to represent and decode the compressed data; these parts may or may not be stored separately. This method can operate with or without the use of psychoacoustic or other perceptual models, with or without the use of Fourier or other transforms, and with or without the use of multiple input/output channels.

### BACKGROUND

1. Field

This method relates to data compression, specifically compression of data which can be represented as linear vectors or matrices.

2. Prior Art

Previously, popular data compression mechanisms and methods achieved high compression ratios in part by discarding data deemed unnecessary, or attempted to losslessly represent all the data at the expense of file size. When, for example, looking specifically at audio compression mechanisms such as the MP3 file standard, much frequency data is discarded at the upper end of the spectrum. Other audio compression mechanisms, such as the FLAC file standard, retain this data but fail to achieve as high of a compression ratio.

This issue plagues more than just audio compression. All media, including audio, video, still images, and text, can benefit from compression. As such, there is a compromise to be made between how much digital space the compressed file consumes, and how true the compressed file is to the original. Currently in audio, video, and stills, the fidelity suffers in order to reduce the space needed to store the media. An added benefit to reducing the space is that less bandwidth is needed to transmit a signal representing a compressed file, as well as less time required to transmit the signal. However, by trading fidelity for ease of transmission, one pays the price that colors and sounds may not be as close as what they originally were.

### SUMMARY

In accordance with one embodiment, a compression mechanism without discarding any data, using a measure of similarity to determine “close enough” matches to stored vector subunits so that when fully assembled a person finds the two indistinguishable or nearly indistinguishable, without actually storing the data losslessly.

### DRAWINGS

### Figures

In the drawings, closely related figures have incremented numbers.

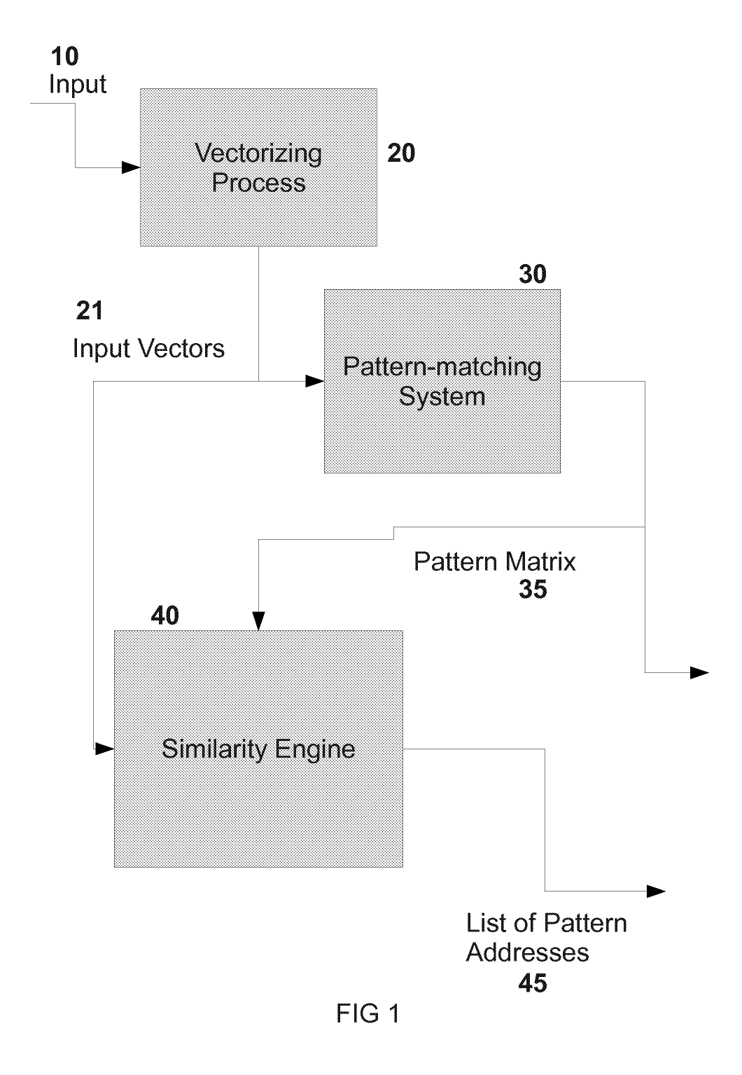

FIG. 1 shows the generalized proposed method of data compression. The pattern matching system 30 consists of both error functions and a method of creating and/or updating a pattern matrix. The similarity engine 40 consists of a method for determining levels of similarity between presented input vectors and patterns stored in the pattern matrix, as well as a method of choosing which pattern in the pattern matrix is most similar to the presented input vector.

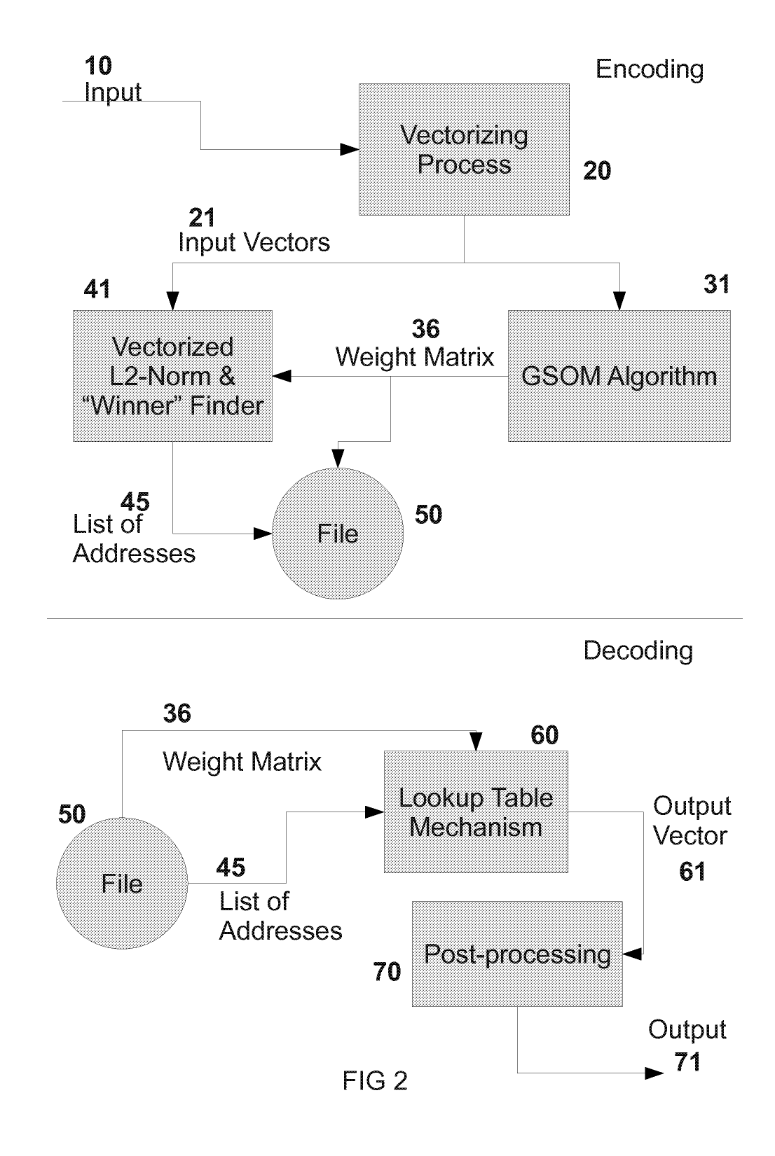

FIG. 2 shows a representation of a simple example of data compression following the method of FIG. 1. In this example, a growing self-organizing map algorithm 31 acts as the pattern matching system. The resultant pattern matrix 36 and list of closest-match addresses 45 are written to file to yield an encoded, compressed data file 50. This file can then be decoded through the use of a lookup table mechanism 60 and then reassembled into the original data or a close representation in post-processing 70.

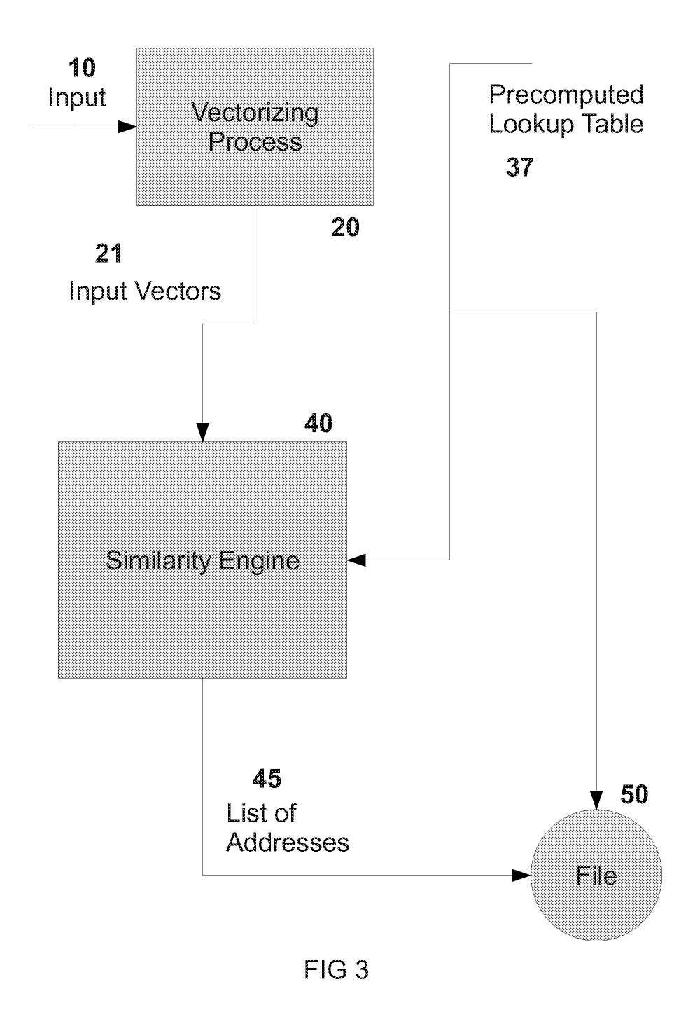

FIG. 3 shows an alternative example of data compression following the method of FIG. 1. In this example, the pattern matching system 30 has been replaced with the results of a precomputed lookup table 37, which may or may not be derived from the actual input to be compressed 10. Such an embodiment would be useful for transmission of compressed data, if the lookup table were already available at the destination.

### REFERENCE NUMERALS

| | | | |
|---|---|---|---|
| 10 | input to be compressed | 20 | vectorizing process |
| 21 | input vectors | 30 | pattern matching system |
| 31 | growing self-organizing map | 35 | pattern matrix/lookup table |
| | algorithm | | |
| 36 | weight matrix | 37 | precomputed lookup table |
| 40 | similarity engine | 45 | index/list of addresses |
| 41 | vectorized L2 norm and winner | 50 | compressed file |
| | finder | | |
| 60 | lookup table mechanism | 61 | output vector |
| 70 | post-processing | 71 | final output |

### DETAILED DESCRIPTION

### FIGS. 1 and 2

### First Embodiment

One embodiment of the general processes of FIG. 1 is illustrated in FIG. 2. This shows a simple single-channel implementation of audio compression. A program written in MATLAB which follows the process described in FIG. 2 can be found attached as “code.zip”.

In the encoding phase of the process, the input 10 is reshaped by vectorizing process 20 to form a number of input vectors 21 which are each of length N. These vectors are presented to a pattern matching system 30, which in this case is a growing self-organizing map algorithm 31, which produces a lookup table or pattern matrix 35, in this case taken from the weight matrix 36 of the algorithm 31. Both the input vectors 21 and the weight matrix 36 are presented to the similarity engine 40, in this case a vectorized version of the L2-norm euclidean distance formula 41. This similarity engine 40 produces a list of winner addresses 45 which represents a sequential listing of which pattern in the weight matrix 36 is most similar to each corresponding sequential input vector 21. Both the weight matrix 36 and the list of addresses 45 are stored into a file 50.

In the decoding phase of the process, the file 50 is read to obtain both the weight matrix 36 and the list of addresses 45. These are presented to a lookup table mechanism 60 which reads each address from the list of addresses 45 and outputs and concatenates each corresponding vector from the weight matrix 36, producing the output vector 61. The output vector 61 may then undergo a level of post-processing 70 involving reshaping the output vector 61 into the expected form to yield an output 71 which should be nearly indistinguishable from the input 10.

### Operation

When a person purchases music in a digital, downloadable form from an online retailer, the music can be stored in a format produced through this process. As long as the customer had the proper decoder software, which as shown in the attached code can be quite trivial to implement, the customer would not be aware a different format was being used than the present one, except for a decreased need for storage space and a higher sound quality. A person who listens to music on a portable media player can simply upgrade the firmware on the device, adding the ability to decode files produced through this process. This would allow devices presently on the market to be used with this new format.

From the perspective of one who produces compressed files through the use of this process, all that would be needed is to give a raw, uncompressed file such as a WAV or AIFF file to the program, as well as a few simple input parameters. In the case of the attached code, the parameters are a sigma value, used to determine adaption strength, a blocksize, and a minimum number of storage addresses. It is entirely possible to compress the files with a modified process which self-determines acceptable quality and, by extension, the number of storage addresses.

### Alternative Embodiment

### FIG. 3

If the lookup table or pattern matrix 35 is not produced from the inputs, and instead is produced as the results of statistical or other analysis of a type of data, then significantly more applications are opened. By storing a precomputed lookup table 37 which contains all possible N-sample vectors of a WAV file at a given number of bits per sample, one can store the table in voice-over IP telephone hardware, reducing the transmitted voice-over IP signal to a small serially-streamed index, decoded as it is received in real-time. Generating different tables for different types of media such as video will work similarly.

### CONCLUSION, RAMIFICATIONS, AND SCOPE

The manner of using the aforementioned process would vary depending on the particular application, but would typically be nearly transparent to the user. Using the attached proof-of-concept MATLAB code, the compressed file size was between 10-25% smaller than a 320 kbps MP3 file, and when analyzing the decompressed resultant WAV for total harmonic distortion, it was lower than the MP3, meaning less distortion and better sound quality. Also, analysis of the average entropy on the resultant files showed that the MP3 file had an entropy of 7.540071 bits per byte, whereas the file produced through this method had an entropy of 7.992291 bits per byte, strongly implying that this method produces files which are not further compressible, meaning the limit of compression is being approached.

As described in the alternate embodiment, the use of a precomputed lookup table, distributed in advance to users either as a file or as part of a device's permanent memory, would allow extremely high levels of apparent compression, as the file would appear to be a simple string of addresses. Used in voice communications, the bandwidth and transmission speed needed to sustain an acceptable signal would drastically decrease. The receiving hardware would need to be a more active device, as it would need to navigate the lookup table fast enough to stream the decoded output signal, but this is not much of a problem, since computing power has been steadily increasing for decades, following Moore's Law.

In nearly every application where data is transmitted, compression can be very valuable. By decreasing the raw amount of data to be sent, usage costs drop, and transmissions can be maintained with poor signal strength and/or harsh conditions.

Although the description above contains many specificities, these should not be construed as limiting the scope of the embodiments but as merely providing illustrations of some of the presently preferred embodiments. For example, a larger number of lookup tables could be used, with the indexes referring to both an address and a lookup table. The table can be arranged in a square fashion as demonstrated, or in another configuration, such as hexagonal. The lookup table can use a higher or lower number of dimensions.

Thus the scope of the embodiments should be determined by the appended claims and their legal equivalents, rather than only by the examples given.

I claim:

1. A method of producing a pattern lookup table and index for accessing said table for purposes of data compression, said method including the steps of: a) reading input data to be compressed; b) vectorizing the read data by representing it as a set of equal size input vectors of length N; c) constructing a pattern lookup table of any size or number of dimensions where said table contains vector representations of length N; d) presenting each input vector to a similarity engine which determines the most similar address in said pattern lookup table for each input vector; e) storing said index and said pattern lookup table to form a compressed representation of said input data.

2. A method according to claim 1, wherein the construction of a pattern lookup table is performed through the use of a self-organizing map algorithm of any type, including but not limited to a growing self-organizing map algorithm.

3. A method according to claim 1, wherein the construction of a pattern lookup table is performed through the use of precomputed statistical analysis of the data to be compressed or data of a similar nature.

4. A method according to claim 1, wherein the index and pattern lookup table are stored in one file for ease of decompression and decoding the compressed data.

5. A method according to claim 1, wherein the index and pattern lookup table are stored in separate files to enable both compression and encryption, where both the index and pattern lookup table are necessary to retrieve the original data.

6. A method according to claim 1 in which the index and pattern lookup table are used to retrieve the original data or a close approximation, said method including the steps of: a) reading the index entries; b) using each index entry to retrieve a vector or matrix pattern from the pattern lookup table; c) concatenating these patterns, in the order the index suggests; d) rotating or reshaping the resultant vector or matrix in order to be in the form expected of the original data.

7. A method according to claims 4 and 6 in which the index and pattern lookup table are read from the same file.

8. A method according to claims 5 and 6 in which the index and pattern lookup table are read from separate files.

9. A method of using a master pattern lookup table to generate an index for accessing said table for purposes of data compression, said method including the steps of: a) loading a precomputed master lookup table containing vector representations of length N; b) reading input data to be compressed; c) vectorizing the read data by representing it as a set of equal size input vectors of length N; d) presenting each input vector to a similarity engine which determines the most similar address in said pattern lookup table for each input vector; e) storing said index to form a compressed representation of said input data.

10. A method according to claim 9 in which the index and master pattern lookup table are used to retrieve the original data or a close approximation, said method including the steps of: a) reading the index entries; b) using each index entry to retrieve a vector or matrix pattern from the master pattern lookup table; c) concatenating these patterns, in the order the index suggests; d) rotating or reshaping the resultant vector or matrix in order to be in the form expected of the original data.

11. A method according to claims 9 and 10 in which the index is stored as a file, and the master lookup table is stored in either hardware or as a file used for compression of many files.
